(19) United States
(12) Patent Application Publication
(10) Pub. No.: US 2017/0342274 A1
(43) Pub. Date: Nov. 30, 2017

(54) AEROSOL-OBTAINED MESOSTRUCTURED PARTICLES LOADED WITH ANTICORROSION AGENTS

(71) Applicants: PYLOTE, Dremil-Lafage (FR); AIRBUS GROUP, Paris (FR); UNIVERSITE PIERRE ET MARIE CURIE (PARIS 6), Paris (FR); CENTRE NATIONAL DE LA RECHERCHE SCIENTIFIQUE, Paris (FR)

(72) Inventors: Loïc MARCHIN, Mons (FR); Marie-Laure DESSE, Portet sur Garonne (FR); Alexandre PERROT, Paris (FR); François RIBOT, Antony (FR); Sophie SENANI, Paris (FR); Lionel NICOLE, Brunoy (FR); Mohamed FATNASSI, Meulan-en-Yvelines (FR)

(21) Appl. No.: 15/535,897

(22) PCT Filed: Dec. 14, 2015
(86) PCT No.: PCT/FR2015/053474

§ 371 Date: Jul. 17, 2017

(30) Foreign Application Priority Data
Dec. 15, 2014 (FR) 1462447

(51) Int. Cl. C09D 5/08; C09D 7/12; B01J 2/04

(52) U.S. Cl. CPC C09D 5/086; B01J 2/04; C09D 7/1291

(57) ABSTRACT

The present invention relates to mesostructured particles that have the particular property of being spontaneously individualized, and that include anticorrosion agents. The invention also relates to a process for preparing these particles, and also to materials obtained by inclusion of these particles in matrices.

The present invention relates to spontaneously individualized, mesostructured, spherical particles that comprise corrosion inhibitors. The invention also relates to a process for preparing these particles.

### PRIOR ART OF THE INVENTION

In the field of materials, it is common to use particles to impart desired properties to a material, since there is a very large range of particles, these particles making it possible to obtain just as large a range of properties. The properties imparted to the material by the nanoparticles and/or microparticles are generally linked to the properties of the particles themselves, such as their morphological, structural and/or chemical properties in particular, the properties imparted to the material may also originate from agents incorporated within the particles.

Particles of spherical morphology are particularly advantageous in various fields. Particles that are said to be spherical are often either clusters of non-spherical particles, the cluster itself having a shape approaching a sphere, or have an unsatisfactory sphericity. Various processes have been developed in order to optimize the sphericity of the particles synthesized. Most of these processes are optimized for a single type of particles, for example a chemical type (silica particles for example) or a morphology (hollow particles for example).

Generally, the particles may have various structures. For example, they may be solid, hollow, porous, non-porous. When they are solid or non-porous, they may be mesostructured, that is to say have a phase segregation that is organized and periodic on the mesoscopic scale, that is to say between 2 and 50 nm, leading to the existence within the particles of at least one three-dimensional network, which may be inorganic, hybrid organic-inorganic, and the other phases possibly being purely organic, hybrid organic-inorganic or inorganic.

It would therefore be advantageous to have mesostructured spherical particles containing corrosion inhibitors in order to impart a corrosion-inhibiting property to the particles and to matrices containing them.

The dispersion of particles in a matrix is also a technique known for imparting a property to said matrix. For example, pigments may be dispersed in matrices in order to impart color properties thereto. The nature of the particles, their surface properties, and optionally their coating should be optimized in order to obtain satisfactory dispersion in the matrix. The optimization of the dispersibility of the particles in the matrix will depend both on the nature of the particles and on the nature of the matrix. It is important to be able to homogeneously disperse the particles in the matrix, in order to homogeneously distribute the desired property throughout the volume of the matrix. When the particles agglomerate in the matrix, the desired properties are not imparted to the matrix in a homogeneous manner and the result obtained is not satisfactory.

It would therefore be advantageous to have novel processes that make it possible to obtain particles that can be dispersed satisfactorily in any matrix, and thus provide the matrix with the corrosion-inhibiting property in a homogeneous manner.

Within this context, the Applicant has developed a simple process that makes it possible to prepare perfectly spherical, micrometric and mesostructured particles of various chemical natures, containing corrosion inhibitors. Surprisingly, the particles obtained by this process, irrespective of their chemical nature, remain in the individualized state and do not form clusters both in the dry state and when they are dispersed in a matrix.

Moreover, the process makes it possible to obtain mesostructured particles, which enables the corrosion inhibitors to be particularly effective.

The process according to the invention enables a higher corrosion inhibitor loading level than the conventional processes by precipitation or impregnation in post-treatment. The process according to the invention makes it possible to obtain micronic and mesostructured spherical particles loaded with corrosion inhibitors, the formation of the particles, their mesostructuration and the incorporation of the corrosion inhibitors being concomitant.

### SUMMARY OF THE INVENTION

The first subject of the present invention is a set of spherical and micrometric particles, characterized in that the particles are mesostructured and individualized, and in that they comprise corrosion inhibitors.

Another subject of the invention is a material comprising a set of particles according to the invention dispersed substantially homogeneously in a matrix.

The invention also relates to a process for preparing a set of particles according to the invention.

The invention also relates to a process for preparing a material according to the invention, comprising the bringing into contact of a matrix with a set of particles according to the invention.

The file of this patent contains at least one drawing executed in color. Copies of this patent with color drawings will be provided by the Patent and Trademark Office upon request and payment of the necessary fee.

### BRIEF DESCRIPTION OF THE FIGURES

FIG. 1: TEM image of silica particles loaded with BTA of example 1A—scale 2 μm-mean diameter 0.71 μm±0.34 μm

FIG. 2: TEM image of silica particles loaded with BTA of example 1A—scale 20 nm

FIG. 3: Small-angle scattering intensity as a function of the wave vector by GISAXS of example 1A

FIG. 4: TEM image of silica particles loaded with BTA of example 1B—scale 2 μm-mean diameter 0.86 μm±0.30 μm

FIG. 5: TEM image of silica particles loaded with BTA of example 1B—scale 20 nm

FIG. 6: Small-angle scattering intensity as a function of the wave vector by GISAXS of example 1B

FIG. 7: TEM image of silica particles loaded with 8HQ of example 2—scale 0.5 μm-mean diameter 0.76 μm±0.43 μm

FIG. 8: TEM image of silica particles loaded with 8HQ of example 2—scale 0.5 μm-mean diameter 0.76 μm±0.43 μm

FIG. 9: Small-angle scattering intensity as a function of the wave vector by GISAXS of example 2

FIG. 10: Schematic representation of a reactor suitable for the implementation of the process according to the invention.

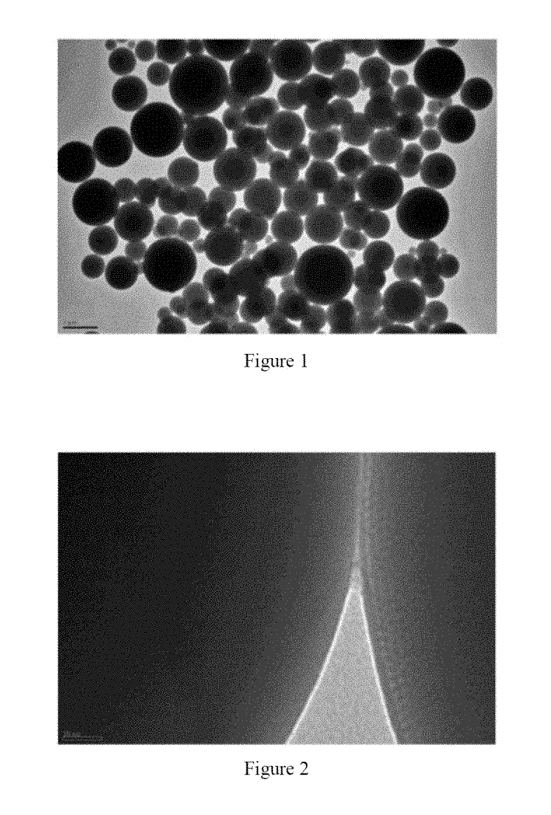

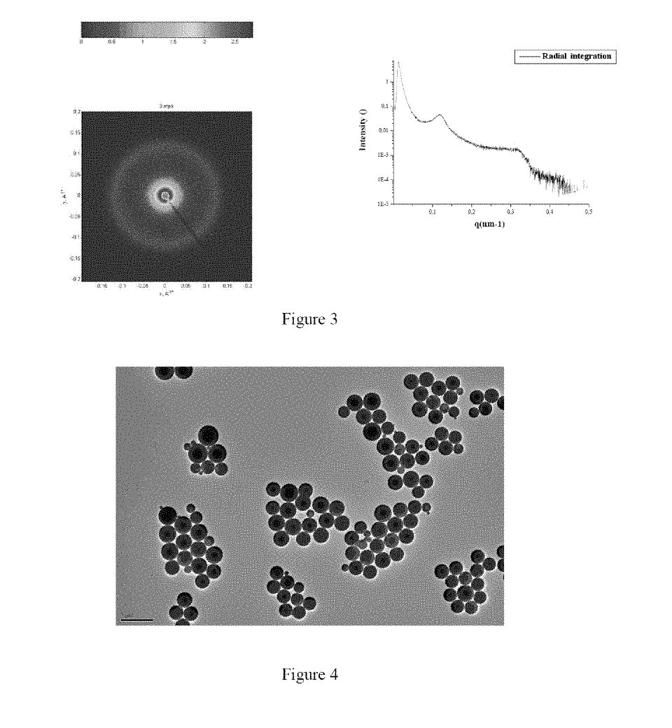

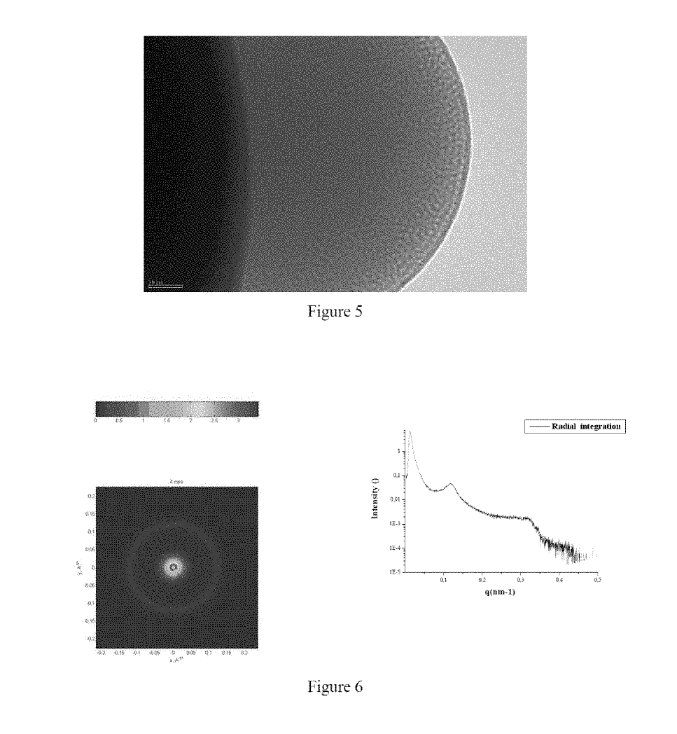

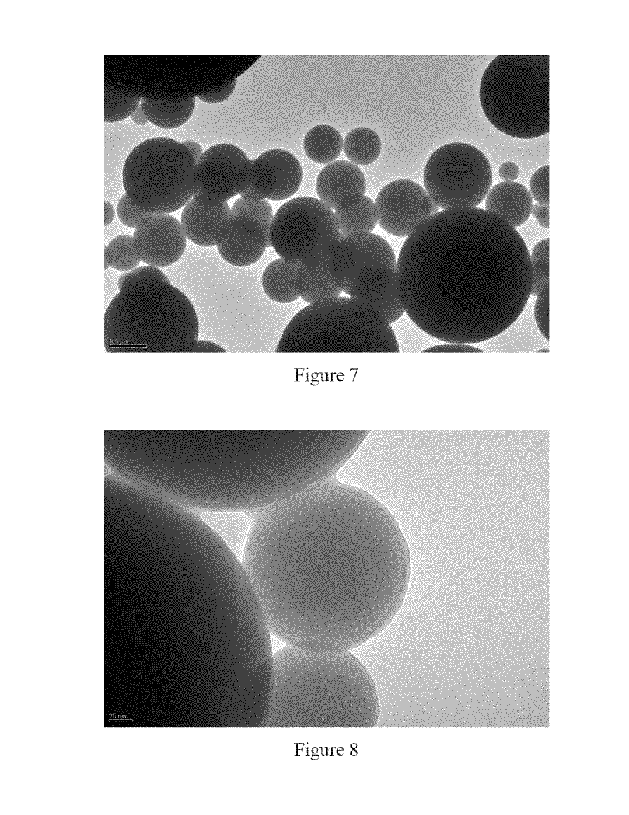

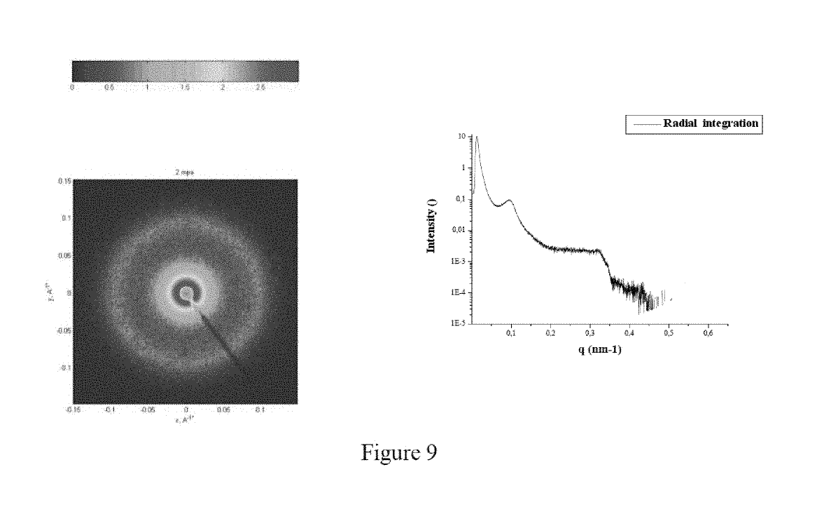

### DETAILED DESCRIPTION OF THE INVENTION

The first subject of the present invention is a set of spherical and micrometric particles, characterized in that the particles are mesostructured and individualized, and in that they have corrosion inhibitors incorporated.

In the present invention, a set of individualized particles denotes a set of particles in which the particles are not clustered, that is to say that each particle of the set is not bonded to other particles by strong chemical bonds such as covalent bonds.

The set of particles according to the invention may optionally contain, in a limited manner, particles that do not meet this characteristic, as long as the non-clustering criterion is respected by at least 50% by number of the particles of the set. Preferably, at least 60%, at least 70%, at least 80%, at least 90%, at least 95% by number of the particles of the set considered are individualized.

Preferably, a particle of the set according to the invention is not formed by the clustering of several particles of small size. This may be clearly seen for example by microscopy studies, in particular scanning or transmission electron microscopy studies. This means that the particles according to the invention can only be formed of domains having a size significantly smaller than that of the particles according to the invention. A particle according to the invention is preferably formed from at least two domains. A domain consists of material having the same chemical nature and the same structure, which may be discrete or extended continuously within the particle.

By way of comparison, the atomization techniques conventionally used in the art generally provide clustered non-spherical particles. The objects that are formed by these clusters of particles may be spherical.

The particles according to the invention are spherical, that is to say that they have a sphericity coefficient of greater than or equal to 0.75. Preferably, the sphericity coefficient is greater than or equal to 0.8, greater than or equal to 0.85, greater than or equal to 0.9, or else greater than or equal to 0.95.

The sphericity coefficient of a particle is the ratio of the smallest diameter of the particle to the largest diameter thereof. For a perfect sphere, this ratio is equal to 1. The sphericity coefficient may be calculated for example by measuring the aspect ratio, using any suitable software, from images, for example images obtained by microscopy, in particular scanning or transmission electron microscopy, of the particles.

In one embodiment, the invention relates to a set of particles as defined above. In this embodiment, the set may optionally contain, in a discrete manner, particles that do not have the required sphericity characteristics as long as the number-average sphericity of the set of the particles meets the criteria set in the present invention. Thus, the terms “set of spherical particles” denotes a plurality of particles, of which at least 50% of the particles by number have a sphericity as defined above. Preferably at least 60%, at least 70%, at least 80%, at least 90%, at least 95% by number of the particles of the set considered have a sphericity as defined above.

The particles according to the invention are micrometric, that is to say that the diameter of the particles is between 0.1 and 600 micrometers, in particular between 0.1 and 100 micrometers. In one preferred embodiment, it is between 0.5 and 20 micrometers or between 1 and 15 micrometers. Those skilled in the art know the techniques suitable for determining the diameter of the particles or of the sets of particles according to the invention, and they also know the degree of uncertainty that exists in these measurements. For example, the mean diameter of the particles of a set, the standard deviation and the distribution of the sizes in particular may be determined by statistical studies using microscopy images, for example scanning or transmission electron microscopy images.

In the case where the particles are within a set, the above diameter values may correspond to the number-average diameter of the particles, even though some of the particles of the set have diameters outside of this range. Advantageously, all particles of the population have a diameter as defined above.

In one embodiment, the standard deviation relating to the size of the particles in a population of particles according to the invention is less than or equal to 25%, preferably less than or equal to 20%.

The distribution of the sizes of the particles in the set of particles according to the invention may be monomodal or multimodal.

The use of micrometric particles in the present invention makes it possible to favor the dispersion properties of particles, since they are not too coarse (the sedimentation is thus minimized), and to not have the drawbacks (processing difficulties, toxicity, etc.) of nanoparticles. Furthermore, this makes it possible to have thin (for example less than 50 microns) corrosion protection layers.

In the present invention the term “particle” denotes a particle having a three-dimensional network that is formed at least partly by an inorganic component, that is to say which is not derived from carbon chemistry (except for CO₃²⁻). Thus, the particles according to the invention are inorganic or hybrid (mixture of inorganic and organic components). The chemical diversity of the inorganic components is well known to a person skilled in the art. The inorganic components may in particular be metals (or alloys), metal oxides, silicates, phosphates (or apatite), borates, fluorides, carbonates, hydroxycarbonates, vanadates, tungstates, sulfides and/or oxysulfides, optionally associated with organic compounds such as for example latices, carboxylates, phosphonates, amines, β-diketonates, this list in no way being limiting. In particular, the inorganic components may comprise oxides of metal or semiconductor elements, such as silica, zinc oxide, magnesium oxide, titanium dioxide, alumina, barium titanate or a mixture thereof. The inorganic components may also comprise transition metals such as copper, zinc or iron, rare-earth elements such as yttrium or lanthanides, and/or derivatives thereof such as oxides.

The inorganic components according to the invention may optionally comprise at least one dopant, such as for example aluminum, erbium, europium or ytterbium. The dopant is included in a proportion of 10% by weight at most, preferably 5% by weight at most, in particular 2% by weight at most.

Of course, the particles according to the invention may comprise a minimum proportion, for example less than or equal to 5% by weight, of contaminants that may have a chemical nature different from that of said particles.

In one preferred embodiment, the inorganic components are alumina, in particular amorphous or crystalline alumina, boehmite, silica, in particular amorphous silica, zinc oxide, in particular hexagonal zinc oxide, which are optionally doped, for example doped with aluminum, copper oxide, titanium dioxide, in particular anatase or rutile titanium dioxide, mixed titanium silicon oxide, in particular mixed anatase titanium silicon oxide, montmorillonite, in particular monoclinic montmorillonite, hydrotalcite, in particular hexagonal hydrotalcite, magnesium dihydroxide, in particular hexagonal magnesium dihydroxide, magnesium oxide, yttrium oxide, in particular cubic yttrium oxide, which are optionally doped with europium and/or with erbium and/or with ytterbium, cerium dioxide, calcium copper titanate, barium titanate, iron oxide, preferably in hematite form, magnesium sulfate, preferably orthorhombic magnesium sulfate.

According to one particular embodiment, the particles according to the invention are composed of metal oxide, preferably of alumina, in particular of amorphous or crystalline alumina, of boehmite, or of silica, in particular of amorphous silica.

In one embodiment, the inorganic component comprises several chemical elements, preferably from 2 to 16 different chemical elements, this number of elements not taking into account the elements O and H optionally included in the inorganic component. These are then heterogeneous inorganic components, that is to say that comprise various elements, the stoichiometry of which is preferably controlled by the method of synthesis.

The heterogeneous inorganic components may either comprise several chemical elements (apart from O and H), preferably all the chemical elements (apart from O and H) forming the inorganic component, within the same domain, or comprise domains each formed of a single chemical element (apart from O and H). In one particular embodiment, each domain of the heterogeneous inorganic component comprises a single chemical element (apart from O and H).

The particles according to the invention are mesostructured, that is to say that they have a phase segregation that is organized and periodic on the mesoscopic scale, that is to say between 2 and 50 nm, leading to the existence within the particles of at least one three-dimensional network, which may be inorganic or hybrid organic-inorganic, and the other phases possibly being purely organic, hybrid organic-inorganic or inorganic.

According to one particular embodiment of the invention, the three-dimensional network of which the particles are composed is formed at least partly by a metal, optionally hybrid organic-inorganic component. This component may be obtained by the sol-gel route from at least one metallic molecular precursor comprising one or more hydrolyzable groups, of formulae (1), (2), (3) or (4) defined below.

According to one particular embodiment of the invention, one of the phases of which the particles are composed is formed at least partly by an organic liquid-crystal phase. One or some amphiphilic surfactants may be used in the invention as precursors of the liquid-crystal phase. These surfactants are preferably amphiphilic surfactants that are ionic, such as anionic or cationic, amphoteric or zwitterionic, or nonionic, and may additionally be photopolymerizable or thermopolymerizable. This surfactant may be an amphiphilic molecule or a macromolecule (or polymer) having an amphiphilic structure. The surfactants preferably used in the present invention are described below.

The anionic surfactants preferably used in the present invention are anionic amphiphilic molecules such as phosphates, for example C₁₂H₂₅OPO₃H₂, sulfates, for example CₚH₂ₚ₊₁OSO₃Na with p=12, 14, 16 or 18, sulfonates, for example C₁₆H₃₃SO₃H and C₁₂H₂₅C₆H₄SO₃Na, and carboxylic acids, for example stearic acid C₁₇H₃₅CO₂H.

As examples of a cationic amphiphilic surfactant, mention may in particular be made of quaternary ammonium salts such as those of formula (I) below or of imidazolium or pyridinium or phosphonium salts.

Particular quaternary ammonium salts are especially selected from those corresponding to the following general formula (I):

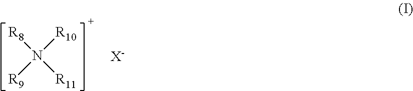

in which the R₈ to R₁₁ radicals, which may be identical or different, represent a linear or branched alkyl group comprising from 1 to 30 carbon atoms, and
X represents a halogen atom, such as a chlorine or bromine atom, or a sulfate.

Mention may in particular be made, among the quaternary ammonium salts of formula (I), of tetraalkylammonium halides, such as, for example, dialkyldimethylammonium or alkyltrimethylammonium halides, in which the alkyl radical comprises approximately from 12 to 22 carbon atoms, in particular behenyltrimethylammonium, distearyldimethylammonium, cetyltrimethylammonium or benzyldimethylstearylammonium halides. The preferred halides are chlorides and bromides.

Mention may in particular be made, as examples of amphoteric or zwitterionic amphiphilic surfactant, of amino acids, such as aminopropionic acids of formula (R₁₂)₃N⁺—CH₂—CH₂—COO⁻ in which each R₁₂, which are identical or different, represents a hydrogen atom or a C₁₋₂₀ alkyl group, such as dodecyl, and more particularly dodecylaminopropionic acid.

The molecular nonionic amphiphilic surfactants which can be used in the present invention are preferably ethoxylated linear C₁₂₋₂₂ alcohols comprising from 2 to 30 ethylene oxide units or esters of fatty acids comprising from 12 to 22 carbon atoms and of sorbitan. Mention may in particular be made, as examples, of those sold under the trade names Brij®, Span® and Tween® by Aldrich, and for example Brij® C10 and 78, Tween® 20 and Span® 80.

The polymeric nonionic amphiphilic surfactants are any amphiphilic polymer having both a hydrophilic nature and a hydrophobic nature. Mention may in particular be made, as examples of such copolymers, of:

fluorinated copolymers CH₃—[CH₂—CH₂—CH₂—CH₂₋₀]ₙ—CO—R₁ with R₁═C₄F₉ or C₈F₁₇, biological copolymers, such as polyamino acids, for example a polylysine, and alginates,
dendrimers, such as those described in G. J. A. A. Soler-Illia, L. Rozes, M. K. Boggiano, C. Sanchez, C. O. Turrin, A. M. Caminade, J. P. Majoral, Angew. Chem. Int. Ed. 2000, 39, No. 23, 4250-4254, and for example (S═)P[O—C₆H₄—CH═N—N(CH₃)—P(═S)—[O—C₆H₄—CH═CH—C(═O)—OH]₂]₃,
block copolymers comprising two blocks, three blocks of A-B-A or A-B—C type or four blocks, and
any other copolymer with an amphiphilic nature known to a person skilled in the art, more particularly those described in Adv. Mater., S. Förster, M. Antonietti, 1998, 10, 195-217 or Angew. Chem. Int, S. Förster, T. Plantenberg, Ed, 2002, 41, 688-714, or Macromol. Rapid Commun, H. Cölfen, 2001, 22, 219-252.

Use is preferably made, in the context of the present invention, of an amphiphilic block copolymer selected from a copolymer based on poly((meth)acrylic acid), a copolymer based on polydiene, a copolymer based on hydrogenated diene, a copolymer based on poly(propylene oxide), copolymers based on poly(ethylene oxide), a copolymer based on polyisobutylene, a copolymer based on polystyrene, a copolymer based on polysiloxane, a copolymer based on poly(2-vinylnaphthalene), a copolymer based on poly(vinylpyridine and N-methylvinylpyridinium iodide) and a copolymer based on poly(vinylpyrrolidone).

Use is preferably made of a block copolymer composed of poly(alkylene oxide) chains, each block being composed of a poly(alkylene oxide) chain, the alkylene comprising a different number of carbon atoms according to each chain.

For example, for a two-block copolymer, one of the two blocks is composed of a poly(alkylene oxide) chain of hydrophilic nature and the other block is composed of a poly(alkylene oxide) chain of hydrophobic nature. For a three-block copolymer, two of the blocks are of hydrophilic nature while the other block, situated between the two hydrophilic blocks, is of hydrophobic nature. Preferably, in the case of a three-block copolymer, the poly(alkylene oxide) chains of hydrophilic nature are poly(ethylene oxide) chains, denoted as (PEO)ᵤ and (PEO)_{w}, and the poly(alkylene oxide) chains of hydrophobic nature are poly(propylene oxide) chains, denoted as (PPO)ᵥ, or poly(butylene oxide) chains, or else mixed chains in which each chain is a mixture of several alkylene oxide monomers. In the case of a three-block copolymer, use may be made of a compound of formula (PEO)ᵤ-(PPO)ᵥ-(PEO)_{w} with 5<u<106, 33<v<70 and 5<w<106. By way of example, use is made of Pluronic® P123 (u=w=20 and v=70) or else of Pluronic® F127 (u=w=106 and v=70), these products being sold by BASF or Aldrich.

The particles according to the invention comprise or contain corrosion inhibitors. Reference is also made to particles loaded with corrosion inhibitors. The corrosion inhibitors may be organic inhibitors or inorganic compounds. They are incorporated during the preparation of the particles.

The corrosion inhibitors of inorganic nature are preferably selected from corrosion inhibitors comprising rare-earth elements, such as salts of cerium, neodymium (III) and praseodymium (III), and/or molybdates, vanadates, tungstates, phosphates, or salts of cobalt Co(III), and of manganese Mn(VII). Mention may in particular be made of CeCl₃, Ce(NO₃)₃, Ce₂(SO₄)₃, Ce(CH₃CO₂)₃, Ce₂(MoO₄)₃, Na₂MoO₄ NaVo₃, NaWO₄-3WO₃, Sr—Al-polyphosphate, zinc phosphate, KH₂PO₄, Na₃PO₄, YCl₃, LaCl₃, Ce(IO₃)₃, or else particles of Mg or of molybdenum, and nanoparticles of silica or of alumina, BaB₂O₄, Na₂SiO₃, Na₂MnO₄; cerium oxide, praseodymium oxide, silicon oxide, antimony tin oxide, barium sulfate, zinc nitroisophtalate, organophilized calcium strontium phosphosilicate, zinc molybdate, modified aluminum polyphosphate.

The corrosion inhibitors of organic nature are preferably selected from inhibitors of azole, amine, mercaptan, carboxylate and phosphonate types. Mention may in particular be made of benzotriazole (BTA), 2-mercaptobenzothiazole, mercaptobenzimidazole, sodium benzoate, nitrochlorobenzene, chloranil, 8-hydroxyquinoline, N-methylpyridine, piperidine, piperazine, 1,2-aminoethylpiperidine, N-2-aminoethylpiperazine, N-methylphenothiazine, β-cyclodextrine, imidazole, pyridine, 2.4-pentanedione, 2,5-dimercapto-1,3,4-thiadiazole (DMTD), N,N-diethyldithiocarbamate (DEDTC), 1-pyrrolydine dithiocarbamate (PDTC), inhibitors consisting of an anthracene molecule bearing imidazolium groups, methyl orange, phenolphthalein, rhodamine, fluorescein, quinizarin, methylene blue or ethyl violet.

The particles according to the invention may be loaded with one or more organic and/or inorganic corrosion inhibitors. When there are several corrosion inhibitors in one and the same particle, it may be a mixture of organic corrosion inhibitors, a mixture of inorganic corrosion inhibitors or a mixture of organic and inorganic corrosion inhibitors.

The corrosion inhibitors may optionally be present in the particles according to the invention in the form of nanoparticles.

In the case of organic corrosion inhibitors, their encapsulation in particles according to the invention makes it possible to formulate these inhibitors in hydrophilic media and thus to make these organic inhibitors active in various types of matrices and in particular hydrophilic matrices. This may also make it possible to protect the corrosion inhibitors, in particular the organic inhibitors, when these are used in a harsh medium.

The particles according to the invention have corrosion inhibitors, the amount of which may vary to a large extent, which depends in particular on the size of the particles, on the geometric characteristics of the phase nanosegregation (tortuosity, constrictions, type of mesophases: vermiform, cubic or 2D-hexagonal for example), on the chemical nature of the interface between the three-dimensional network and the other phases, and also on the desired application. For example, the ratio of the corrosion inhibitors may vary from 5% to 90% by volume relative to the total volume of particles+corrosion inhibitors, preferably from 10% to 80% by volume, in particular from 10% to 50%.

The type of nanosegregation and also the chemical nature of the three-dimensional network-other phases interface of the particles according to the invention makes it possible to control in particular the release rate of the corrosion inhibitor. The release rate of the inhibitor may also depend on the matrix itself. The release rate of the corrosion inhibitor may also depend on a stimulus. Thus, by way of example, it is possible to deliver the inhibitor under the action of an external stimulus, such as the change of pH, the admission of water (which is the case when a material corrodes of when the coating which makes a barrier with the outside is damaged), a modification of the salinity, etc.

It is also possible to add a post-treatment step which consists in making the particles impermeable, at least momentarily, the objective of which is in particular to prolong the release of the corrosion inhibitor. Thus, the particles according to the invention may have shells that are degradable, in particular, by the action of an external stimulus of pH type (by dissolving), mechanical type (fragile shell), thermal type (shell that melts with temperature rise) or optical type (shell that disintegrates under irradiation).

Another subject of the invention is a material comprising a set of particles according to the invention, dispersed substantially homogeneously in a matrix.

According to the present invention, the term matrix denotes any material that may advantageously benefit from the inclusion of particles according to the invention. It may in particular be a question of solid or liquid matrices, irrespective of the viscosity of the initial liquid matrix.

In one embodiment, the matrix is a flexible, rigid or solid matrix used as coating, for example a metal, ceramic or polymer matrix, in particular a polymer matrix of paint, sol-gel layers or varnish type, or a mixture thereof. The matrix may thus be deposited on a substrate that is liable to corrode, such as a metal substrate.

The inclusion of the particles according to the invention in a matrix makes it possible to impart the corrosion-inhibiting property to the matrix. The inclusion of the particles in the matrix may be carried out by the techniques conventionally used in the art, in particular by mechanical stirring when the matrix is liquid.

The material according to the invention may in particular be in the form of powder, beads, pellets, granules, films, foam and/or extrudates, the shaping operations being carried out by the conventional techniques known to a person skilled in the art.

In particular, the material shaping process does not require an additional step of dispersing the particles within the matrix compared to the shaping process conventionally used for matrices with no inclusion of particles. The shaping process may preferably be implemented on the conversion equipment and dies conventionally used for matrices with no inclusion of particles. The dispersion of the particles within the matrix may, in certain embodiments, be carried out without an additional chemical dispersant.

In one particular embodiment, the dispersion of the particles within the matrix is carried out in the presence of a chemical dispersant such as a surfactant. A person skilled in the art is able to determine whether the use of a dispersant is necessary for obtaining the desired dispersion and to adapt the amount of dispersant to be used where appropriate.

For example, the dispersant may be used in an amount of from 0.1% to 50% by weight relative to the weight of particles, in particular in an amount of 0.5% to 20% by weight relative to the weight of particles.

The particles according to the invention have the distinctive feature of dispersing substantially homogeneously by volume in the matrix, irrespective of their chemical nature, their morphology and the nature of the matrix. This means that the density of particles per unit of volume is the same at any point of the matrix.

In the case of a solid matrix, the density of particles per unit of surface area is preferably roughly the same irrespective of the surface of the matrix considered, whether it is an extremity surface area of the matrix, or a “core” surface area obtained by cutting the material for example. Thus, the corrosion-inhibiting property imparted to the matrix by the inclusion of the particles according to the invention is distributed substantially homogeneously throughout the whole of the matrix volume.

The material according to the invention may comprise particles according to the invention in any proportion suitable for giving it the desired properties. For example, the material may comprise from 0.1% to 80% by weight of particles relative to the total weight of matrix+particles, preferably from 1% to 60% by weight, in particular from 2% to 25% by weight.

Preferably, the particles according to the invention are non-deformable individualized particles. Therefore, the surface area of each particle that is in contact with other particles is very small. In one embodiment, the radius of curvature of the meniscus forming the contact between two different particles of the set is less than 5%, preferably less than 2%, of the radius of each of the two particles, in particular within a matrix or in powder form.

The sphericity of the particles according to the invention also makes it possible, for a same loading level in a liquid matrix, to obtain a lower viscosity than with non-spherical particles.

The particles according to the invention may be obtained by a process comprising non-dissociable and continuous steps in one and the same reactor of nebulization-heating, the step of loading with (or of incorporating) corrosion inhibitors and of preparing particles being carried out simultaneously, in particular carried out in the nebulization step. The process according to the invention makes it possible to obtain spherical, micronic, mesostructured particles that are loaded with corrosion inhibitors, the formation of the particles (and in particular the mesostructuring thereof) and the incorporation of the corrosion inhibitors being concomitant.

Thus, another subject of the present invention is a process for preparing a set of particles according to the invention. The process according to the invention is a so-called “aerosol pyrolysis” (or spray pyrolysis) process that is carried out at drying temperatures that are not necessarily pyrolysis temperatures. This process is an improved process relative to the aerosol pyrolysis process in particular described in application FR 2 973 260. More specifically, the process according to the invention is generally carried out in a nebulization-heating reactor, as described in detail below.

This process comprises the following non-dissociable and continuous steps in one and the same reactor:

(1) nebulization, in a reactor, of a liquid solution containing one or more precursors of the three-dimensional network of the particles, at a given molar concentration in a solvent, so as to obtain a mist of droplets of solution, the liquid solution additionally comprises at least one corrosion inhibitor and optionally at least one surfactant,
(2) heating of the mist at a so-called drying temperature capable of ensuring the evaporation of the solvent and of the volatile compounds and the formation of particles,
(3) heating of these particles at a temperature (referred to as pyrolysis temperature) capable of ensuring the transformation of the precursor(s) in order to form the inorganic portion of said network,
(4) optionally, densification of the particles, and
(5) recovery of the particles thus formed.

The nebulization step (1) is preferably carried out at a temperature of from 10° C. to 40° C., and/or preferably over a duration of less than or equal to 10 seconds, in particular less than or equal to 5 seconds. In step (1), the liquid solution is generally in the form of an aqueous or aqueous-alcoholic solution or in the form of a colloidal sol. More specifically, the liquid solution of step (1) is introduced into a reactor by nebulization.

The heating (drying) step (2) is preferably carried out at a temperature of from 40° C. to 120° C., and/or preferably over a duration of less than or equal to 10 seconds, in particular between 1 and 10 seconds.

The so-called pyrolysis step (3) is preferably carried out at a temperature of from 120° C. to 400° C., and/or preferably over a duration of less than or equal to 30 seconds, in particular between 10 and 30 seconds.

The optional densification step (4) may be carried out over a wide range of temperatures, in particular between 200° C. and 1000° C. This step is preferably carried out at a temperature of from 400° C. to 1000° C. when the particles that it is desired to prepare are at least partly in crystallized form. When it is desired to obtain dense but non-crystallized particles, in particular amorphous particles, the densification temperature may be lower, for example it may be in the vicinity of from 200° C. to 300° C., in particular for amorphous silica. Preferably, the densification step is carried out over a duration of less than or equal to 30 seconds, in particular between 20 and 30 seconds.

The recovery step (5) is preferably carried out at a temperature below 100° C., and/or preferably over a duration of less than or equal to 10 seconds, in particular less than or equal to 5 seconds. The particle recovery step (5) is preferably carried out by depositing the particles on a filter at the outlet of the reactor.

The advantage of the process according to the invention is that it may be carried out in a relatively short time. The duration of the process according to the invention may be for example less than a few minutes (for example 2 or 3 minutes, or even one minute).

The temperatures of each of the steps may lie outside of the ranges of temperatures provided above. Indeed, for the same particles, the temperature to be applied could depend on the velocity at which the droplets, the drops then the particles circulate in the reactor. The faster the droplets, the drops then the particles circulate in the reactor, the less time they spend therein and the higher the setpoint temperature should be in order to obtain the same result.

Preferably, the steps (2), (3), and optionally (4), are carried out in one and the same reactor. In particular, all of the steps of the process (with the exception of the optional post-treatment steps) are carried out in the same reactor.

Preferably, the steps (2), (3), and optionally (4), are carried out at increasing temperatures.

All of the steps of the process, in particular the steps (2), (3) and optionally (4), are carried out following on from one another. The temperature profile applied in the reactor is suitable, as a function of the particles that it is desired to form, for these two or three steps to take place one after the other. Preferably, the temperature in the reactor is adjusted by means of at least one, preferably 2 or 3, heating elements, the temperatures of which may be defined independently.

The process according to the present invention preferably also comprises, between step (3), or optionally the particle densification step (4) when it is carried out, and the particle recovery step (5), a step (4′) of quenching the particles. The quenching step (4′) is referably carried out by admission of a cold gas, preferably air, over all or some of the circumference of the reactor. A gas is said to be cold in the present invention if it is at a temperature between 15° C. and 50° C., preferably between 15° C. and 30° C. In one embodiment, the gas entering the reactor is a gas other than air. In particular, it may be an inert gas (such as nitrogen or argon), a reducing gas (such as hydrogen or carbon monoxide) or any mixture of such gases.

The process is preferably carried out in the absence of a gas flow transporting the mist from the bottom of the reactor. The laminar flow that makes it possible to bring the material into the zone in which the temperature is lower is advantageously created solely by suction at the top of the reactor, producing a vacuum for example of the order of several pascals or several tens of pascals.

Such an embodiment makes it possible to use a reactor with no gas inlet in its lower portion, thus limiting the disturbances of the process and the losses, and thus optimizing the yield of the process and the size distribution of the particles obtained. In another embodiment, the reactor in which the process is carried out also comprises a gas inlet at the level where the mist is formed. The gas that enters the reactor at this level is preferably air, in particular hot air, that is to say at a temperature of 80° C. to 200° C.

Preferably, the process according to the invention comprises no other heating step than those carried out inside the aerosol pyrolysis reactor.

Given the capacity of the process according to the invention to be rapid, and the optional existence of a quenching step at the end of the process for preparing the particles according to the invention, these particles may comprise any chemical constituent that it is possible to densify, in particular to crystallize, even metastable phases. Specifically, the particular conditions used in the process make it possible to preserve compounds that have a degradation temperature below the temperature actually applied, since the time spent at high temperature is very short. In this context, the terms “high temperature” preferably denote a temperature above 40° C. The “time spent at high temperature” generally denotes the time spent for the drying, pyrolysis and densification steps. Preferably, the time spent at high temperature does not exceed 70 seconds, in particular it is between 30 and 70 seconds. Preferably, the quenching is characterized by a cooling rate greater than or equal to 100° C. per second. In one embodiment, the particles according to the invention comprise a type of oxide which requires an input of energy in order to densify, in particular in order to crystallize. Mention may be made, for example, of alumina, zinc oxide, iron oxide, (rutile) titanium dioxide, and oxides of rare-earth elements (lanthanides and/or yttrium). Such particles may not be obtained in the same way by the conventional processes used in the prior art, especially those that do not comprise a quenching step. A person skilled in the art is able to adjust the temperature and the time spent in each of the steps as a function of the compounds introduced in step (1).

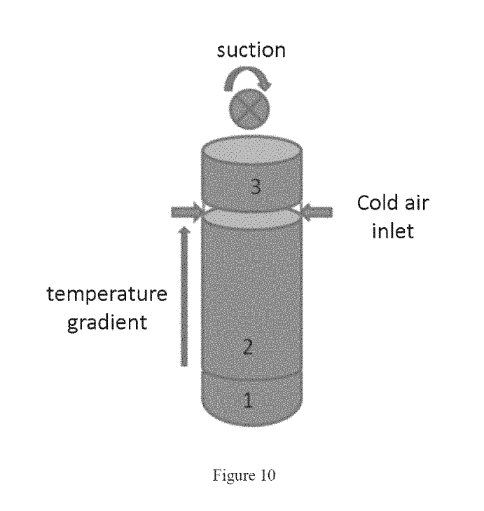

FIG. 10 presents a schematic example of a reactor for the implementation of the process according to the invention. The bottom portion (1) of the reactor comprises the liquid solution containing a precursor or precursors of the three-dimensional network at a given molar concentration in a solvent. This solution is nebulized level with the intermediate portion (2), and the droplets rise by suction in the reactor. The cold inlet gas, in particular cold air, enables a quenching of the particles. The upper portion (3) of the reactor is also at a cold temperature (below 100° C., for example between 15° C. and 50° C.).

The precursor or precursors of the three-dimensional network of the particles may be of any origin, it (they) is (are) introduced in step (1) of the process in the form of a liquid solution, in particular an aqueous or aqueous-alcoholic solution containing metal ions (such as an organic or mineral salt of the metal considered) or the precursor molecules (such as organosilanes) or else in the form of a colloidal sol (such as a colloidal dispersion of nanoparticles of the metal or of the oxide of the metal considered). The precursor(s) of the three-dimensional network is or are selected as a function of the particles that it is desired to form.

In one particular embodiment, this precursor is at least partially derived from plant or food waste, which represent biosources. As examples of such precursors of inorganic material, mention may in particular be made of sodium silicate derived from rice hulls.

As specified previously, according to one particular embodiment of the invention, the three-dimensional network of which the particles are composed is formed at least partly by a metal, optionally hybrid organic-inorganic component. This component may be obtained by the sol-gel route from at least one metallic molecular precursor comprising one or more hydrolyzable groups, of formulae (1), (2), (3) or (4), optionally in the presence of at least one amphiphilic surfactant (or particular texturing agent) as defined above, the surfactant being retained in the final material.

A hydrolyzable group is understood to mean a group capable of reacting with water to give an —OH group, which will itself undergo a polycondensation.

Said metallic molecular precursor(s) comprising one or more hydrolyzable groups is selected from a metal alkoxide or halide, preferably a metal alkoxide, or a metal alkynyl, of formula (1), (2), (3) or (4) below:

MZₙ (1),

L^{m}ₓMZₙ₋ₘₓ (2),

R′_{x′}SiZ_{4-x′} (3), or

Z₃Si—R″—SiZ₃ (4)

in which formulae (1), (2), (3) and (4):
M represents Al(III), Ce(III), Ce(IV), Si(IV), Zr(IV), the number between parentheses being the valence of the atom M;
n represents the valence of the atom M;
x is an integer ranging from 1 to n−1;
x′ is an integer ranging from 1 to 3;
each Z, independently of one another, is selected from a halogen atom and an —OR group, and preferably Z is an —OR group;
R represents an alkyl group preferably comprising 1 to 4 carbon atoms, such as a methyl, ethyl, n-propyl, i-propyl, n-butyl, s-butyl or t-butyl group, preferably a methyl, ethyl or i-propyl group, better still an ethyl group;
each R′ represents, independently of one another, a non-hydrolyzable group selected from alkyl groups, in particular C₁₋₄ alkyl groups, for example methyl, ethyl, propyl or butyl groups; alkenyl groups, in particular C₂₋₄ alkenyl groups, such as vinyl, 1-propenyl, 2-propenyl and butenyl groups; alkynyl groups, in particular C₂₋₄ alkynyl groups, such as acetylenyl and propargyl groups; aryl groups, in particular C₆₋₁₀ aryl groups, such as phenyl and naphthyl groups; methacryl or methacryloxy(C₁₋₁₀ alkyl) groups such as a methacryloxypropyl group; epoxyalkyl or epoxyalkoxyalkyl groups in which the alkyl group is a linear, branched or cyclic C₁₋₁₀ alkyl group and the alkoxy group comprises from 1 to 10 carbon atoms, such as glycidyl and glycidyloxy(C₁₋₁₀ alkyl) groups; C₂₋₁₀ haloalkyl groups such as a 3-chloropropyl group; C₂₋₁₀ perhaloalkyl groups such as a perfluoropropyl group; C₂₋₁₀ mercaptoalkyl groups such as a mercaptopropyl group; C₂₋₁₀ aminoalkyl groups such as a 3-aminopropyl group; (amino(C₂₋₁₀ alkyl))amino(C₂₋₁₀ alkyl) groups such as a 3-[(2-aminoethyl)amino]propyl group; di(C₂₋₁₀ alkylene)triamino(C₂₋₁₀ alkyl) groups such as a 3-[diethylenetriamino]propyl group and the imidazolyl(C₂₋₁₀ alkyl) groups;
L represents a monodentate or polydentate, preferably polydentate, complexing ligand, for example a carboxylic acid, preferably a C₁₋₁₈ carboxylic acid, such as acetic acid, a β-diketone, preferably a C₅₋₂₀ β-diketone such as acetylacetone, a β-ketoester, preferably a C₅₋₂₀β-ketoester, such as methyl acetoacetate, a β-ketoamide, preferably a C₅₋₂₀ β-ketoamide such as an N-methylacetoacetamide, an α- or β-hydroxyacid, preferably a C₃₋₂₀ α- or β-hydroxyacid such as lactic acid or salicylic acid, an amino acid such as alanine, a polyamine such as diethylenetriamine (or DETA), or a phosphoric acid or a phosphonate;
m represents the degree of hydroxylation of the ligand L; and
R″ represents a non-hydrolyzable function selected from alkylene groups, preferably C₁₋₁₂ alkylene groups, for example methylene, ethylene, propylene, butylene, hexylene, octylene, decylene and dodecylene groups; alkynylene groups, preferably C₂₋₁₂ alkynylene groups, for example acetylenylene (—C≡C—), —C≡—C≡C—, and —C≡C—C₆H₄—C≡C— groups; N,N-di(C₂₋₁₀ alkylene)amino groups such as an N,N-diethyleneamino group; bis[N,N-di(C₂₋₁₀ alkylene)amino] groups such as a bis[N-(3-propylene)-N-methyleneamino] group; C₂₋₁₀ mercaptoalkylene groups such as a mercaptopropylene group; (C₂₋₁₀ alkylene)polysulfide groups such as a propylene-disulfide or propylene-tetrasulfide group; alkenylene groups, in particular C₂₋₄ alkenylene groups, such as a vinylene group; arylene groups, in particular C₆₋₁₀ arylene groups, such as a phenylene group; di(C₂₋₁₀ alkylene)(C₆₋₁₀ arylene) groups such as a di(ethylene)phenylene group; N,N′-di(C₂₋₁₀ alkylene)ureido groups such as an N,N′-dipropyleneureido group; and the following groups:
of thiophene type such as

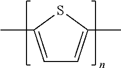

with n=1-4,
of C₂₋₅₀ aliphatic and aryl(poly)ether or (poly)thioether type, such as —(CH₂)ₚ—X—(CH₂)ₚ—, —(CH₂)ₚ—C₆H₄—X—C₆H₄—(CH₂)ₚ—, —C₆H₄—X—C₆H₄—, and —[(CH₂)ₚ—X]_{q}(CH₂)ₚ—, with X representing O or S, p=1-4 and q=2-10,
of crown ether type such as

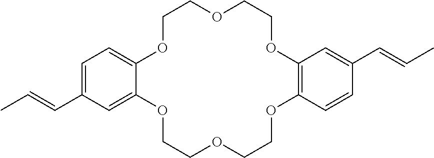 [SMILES: C/C=C/c1ccc2c(c1)OCCOCCOc1ccc(/C=C/C)cc1OCCOCCO2]

of organosilane type such as:
   —CH₂CH₂—SiMe₂-C₆H₄—SiMe₂-CH₂CH₂—,
   —CH₂CH₂—SiMe₂-C₆H₄—C₆H₄—SiMe₂-CH₂CH₂— and
   —CH₂CH₂—SiMe₂-C₂H₄—SiMe₂-CH₂CH₂—,
of C₁₋₁₈ fluoroalkylene type such as —(CF₂)ᵣ— with r=1-10, —CH₂CH₂—(CF₂)₆—CH₂CH₂— and —(CH₂)₄—(CF₂)₁₀—(CH₂)₄—,
of Viologen type

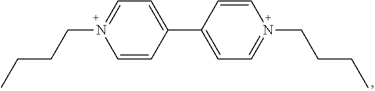

or else
of trans-1,2-bis(4-pyridylpropyl)ethene type

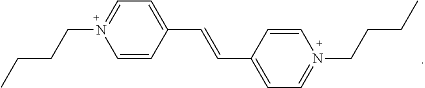

Preferably M is other than Si for the formula (2).

As examples of compounds of formula (1), mention may in particular be made of tetra(C₁₋₄ alkoxy)silanes and zirconium n-propoxide Zr(OCH₂CH₂CH₃)₄.

As examples of compounds of formula (2), mention may in particular be made of: aluminum di-s-butoxy ethylacetoacetate (CH₃CH₂OC(O)CHC(O)CH₃)Al(CH₃CHOCH₂CH₃)₂, zirconium dichloride bis(2,4-pentanedionate) [CH₃C(O)CHC(O)CH₃]₂ZrCl₂, zirconium diisopropoxy-bis(2,2,6,6-tetramethyl-3,5-heptanedionate) [(CH₃)₃CC(O)CHC(O)C(CH₃)₃]₂Zr[OCH(CH₃)₂]₂.

As examples of an organoalkoxysilane of formula (3), mention may in particular be made of 3-aminopropyltrialkoxysilane (RO)₃Si—(CH₂)₃—NH₂, 3-(2-aminoethyl)aminopropyltrialkoxysilane (RO)₃Si—(CH₂)₃—NH—(CH₂)₂—NH₂, 3-(trialkoxysilyl)propyldiethylenetriamine (RO)₃Si—(CH₂)₃—NH—(CH₂)₂—NH—(CH₂)₂—NH₂; 3-chloropropyl [symbol] trialkoxysilane (RO)₃Si—(CH₂)₃Cl, 3-mercaptopropyltrialkoxysilane (RO)₃Si—(CH₂)₃SH; organosilyl azoles of N-(3-trialkoxysilylpropyl)-4, 5-dihydroimidazole type, R having the same meaning as above.

As examples of a bisalkoxysilane of formula (4), use is preferably made of a bis[trialkoxysilyl]methane (RO)₃Si—CH₂—Si(OR)₃, a bis[trialkoxysilyl]ethane (RO)₃Si—(CH₂)₂—Si(OR)₃, a bis[trialkoxysilyl]octane (RO)₃Si—(CH₂)₈—Si(OR)₃, a bis[trialkoxysilylpropyl]amine (RO)₃Si—(CH₂)₃—NH—(CH₂)₃—Si(OR)₃, a bis[trialkoxysilylpropyl]ethylenediamine (RO)₃Si—(CH₂)₃—NH—(CH₂)₂—NH—(CH₂)₃—Si(OR)₃; a bis[trialkoxysilylpropyl]disulfide (RO)₃Si—(CH₂)₃S₂—(CH₂)₃—Si(OR)₃, a bis[trialkoxysilylpropyl]tetrasulfide (RO)₃Si—(CH₂)₃—S₄—(CH₂)₃—Si(OR)₃, a bis[trialkoxysilylpropyl]urea (RO)₃Si—(CH₂)₃—NH—CO—NH—(CH₂)₃—Si(OR)₃; a bis[trialkoxysilylethyl]phenyl (RO)₃Si—(CH₂)₂—C₆H₄—(CH₂)₂—Si(OR)₃, R having the same meaning as above.

For the present invention, hybrid organic-inorganic is understood to mean a network consisting of molecules corresponding to the formulae (2), (3) or (4).

According to one particular embodiment of the invention, one of the phases of which the particles are composed is formed at least partly by an organic liquid-crystal phase. One or some amphiphilic surfactants may be used in the invention as precursors of the liquid-crystal phase. The surfactants that can be used are defined above.

The corrosion inhibitors may be introduced into the liquid solution in step (1) either in dry form or in the form of a liquid solution. When the corrosion inhibitors are nanoparticles, they may be introduced into the liquid solution of step (1) in the form of an aqueous or aqueous-alcoholic suspension comprising nanoparticles or else in dry form to be dispersed in the liquid solution of step (1) of the process according to the invention. When the corrosion inhibitors are salts, they may be introduced into the liquid solution of step (1) in dry form or in dissolved form in an aqueous or aqueous-alcoholic solution.

The process according to the invention makes it possible to obtain particles having a high degree of purity. These particles do not necessarily require the implementation of subsequent treatment steps, such as a washing, a heat treatment, a milling, etc., before the use thereof.

In the process according to the invention, the components introduced unused in the reactor are converted, which is a significant advantage since the process generates little waste. Moreover, the level of use of the atoms is high and complies with the requirements of green chemistry.

The process according to the invention may optionally comprise at least one step of post-treatment of the particles. For example, it may be a step of washing with a suitable solvent, a step of bringing into contact with reducing conditions, a step of heating the particles, and/or a step of coating the particles, in particular to “impermeabilize” said particles.

In particular, a step of post-treatment by heating of the particles may be necessary in order to optimize the properties of the particles such as their composition or their crystalline structure. A step of post-treatment by heating of the particles will generally be proportionately less necessary the lower the velocity of the drops then of the particles in the reactor.

The process according to the invention makes it possible to precisely control the size of the particles at the outlet of the process. Specifically, there is a constant ratio, which is in the vicinity of 5, between the diameter of the drops of the mist used and the diameter of the particles at the outlet of the process when the precursor concentrations are molar, which is usually the case. A person skilled in the art knows how to determine, as a function of the precursor concentration, the ratio between these two diameters. For example, if the precursor concentration is reduced by a factor of 10, then the size of the particles obtained is reduced by a factor of the cube root of 10, i.e. around 3. The diameter of the drops may moreover be controlled in particular by the parameters of the nebulization mode, for example the frequency of the piezoelectric elements used to form the mist.

The process according to the invention also makes it possible to precisely control the size of the pores at the outlet of the process. The size of the pores is controlled by the choice of the precursor compounds of the solution, their concentrations, the pH and the presence of the corrosion inhibitors and the optional addition of a surfactant to the liquid solution of step (1). The surfactant may thus act as a mesostructuring agent.

According to one particular embodiment of the process according to the invention, the liquid solution of step (1) additionally comprises at least one surfactant, as defined above.

In the particular case of silica, which is the favored matrix for the mesoporous materials, the precursor will condense around the micelles of surfactants in an aqueous medium.

The concentration of surfactants in the solution may vary to a large extent. To give an order of magnitude, and according to one particular embodiment, the concentration of surfactants is between 0.001 and 0.1 mol per 1 mol of precursor of the metal considered.

Another subject of the invention is a set of particles capable of being prepared according to the process defined above. The particles thus prepared have the features described above. This process makes it possible in particular to obtain individualized spherical particles. Preferably, it also makes it possible for each particle not to be formed by the clustering of several particles of small size. Preferably, the particles obtained by this process are individualized and non-deformable.

A final subject of the invention is a process for preparing a material according to the invention, comprising the bringing into contact of a matrix as defined above with at least one set of particles according to the invention. This process then preferably comprises a step of shaping the material as described above.

Unless otherwise specified, the percentages mentioned in the present invention are weight percentages.

The following examples are provided by way of nonlimiting illustration of the invention.

### Examples

Unless otherwise specified, in the present examples, the measurements of specific surface area, pore volume and pore diameter were carried out by nitrogen volumetric analysis and by the BET method on calcined particles.

The LASER particle size measurements were carried out, with the aid of a LASER Mastersizer 2000 (Malvern Instruments) particle size analyzer, on dispersions of the particles in water.

The presence of mesostructures within the particles was determined on the particles, after calcination at 550° C., by observation of transmission electron microscopy images and by determination of the correlation peaks on the diffuse intensity measurements by GISAXS (Grazing Incidence Small Angle X-Ray Scattering).

The following examples were carried out according to the process described above, in one and the same reactor, with a solution introduced in step (1) as described in each of the examples below.

Table 1 below recapitulates the examples described in detail below.

The notation “Eq SiO₂” corresponding to the equivalent weight of silica calculated relative to the chosen precursor.

The surfactant loading level, given in weight %, corresponding to the ratio of the weight of surfactant to the total weight (Eq SiO₂+surfactant+corrosion inhibitor).

The corrosion inhibitor loading level, given in weight %, corresponding to the ratio of the weight of corrosion inhibitor to the total weight (Eq SiO₂+surfactant+corrosion inhibitor)

The loading levels are the weight ratios introduced into the precursor solution before step (1) of the process.

TABLE 1

| | | | mol | Surfac- | | Corrosion |
|---|---|---|---|---|---|---|
| | | | surfac- | tant | Corro- | inhibitor |
| Exam- | | Surfac- | tant/ | loading | sion in- | loading |
| ple | Eq SiO₂ | tant | mol Si | level | hibitor | level |
| 1a | 65 wt % | BrijC10 | 0.03 | 22 wt % | BTA | 13 wt % |
| 1b | 57 wt % | BrijC10 | 0.03 | 20 wt % | BTA | 23 wt % |
| 1c | 48 wt % | BrijC10 | 0.06 | 33 wt % | BTA | 19 wt % |
| 2 | 57 wt % | BrijC10 | 0.03 | 20 wt % | 8HQ | 23 wt % |
| 3 | 83 wt %** | — | — | — | BTA | 17 wt % |

Brij ®C10: Polyethylene glycol hexadecyl ether, sold by Sigma-Aldrich
* use of MTEOS/TEOS mixture in order to give the particles a more hydrophobic nature
**silica nanoparticles
TEOS: tetraethoxysilane
MTEOS: methyltriethoxysilane
BTA: benzotriazole
8HQ: 8-hydroxyquinoline

### Example 1: Preparation of Micronic Mesostructured Particles Loaded with Benzotriazole (BTA)-Acetic Acid (AcOH) Sol-Gel Catalyst

1A/Preparation of the solution: the following compounds are added, in order and under magnetic stirring, to a polypropylene flask: 27.5 g of a 0.1M aqueous solution of AcOH and 5.30 g (i.e. 1.5 g of silica) of TEOS. The solution is then kept stirring at 25° C. for 24 hours in order to enable the hydrolysis-condensation of the TEOS. After aging, 0.53 g of Brij®C10 is dissolved in 5.82 g of ethanol, heating at 37° C. for 5 minutes possibly being used in order to favor the dissolving of the Brij®C10 in the aqueous-alcoholic solution, then this solution is mixed with the silica precursor solution. Lastly, 0.31 g of BTA powder is finally added to the solution.

1B/Preparation of the solution: the following compounds are added, in order and under magnetic stirring, to a polypropylene flask: 27.5 g of a 0.1M aqueous solution of AcOH and 5.30 g (i.e. 1.5 g of silica) of TEOS. The solution is then kept stirring at 25° C. for 24 hours in order to enable the hydrolysis-condensation of the TEOS. After aging, 0.53 g of Brij®C10 is dissolved in 5.82 g of ethanol, heating at 37° C. for 5 minutes possibly being used in order to favor the dissolving of the Brij®C10 in the aqueous-alcoholic solution, then this solution is mixed with the silica precursor solution. Lastly, 0.61 g of BTA powder is finally added to the solution.

1C/Preparation of the solution: the following compounds are added, in order and under magnetic stirring, to a polypropylene flask: 27.5 g of a 0.1M aqueous solution of AcOH and 5.30 g (i.e. 1.5 g of silica) of TEOS. The solution is then kept stirring at 25° C. for 24 hours in order to enable the hydrolysis-condensation of the TEOS. After aging, 1.06 g of Brij®C10 are dissolved in 5.82 g of ethanol, heating at 37° C. for 5 minutes possibly being used in order to favor the dissolving of the Brij®C10 in the aqueous-alcoholic solution, then this solution is mixed with the silica precursor solution. Lastly, 0.61 g of BTA powder is finally added to the solution.

In each case, the silica precursor/Brij/BTA solution is nebulized by the spray pyrolysis process according to the invention in step (1).

In steps (2) and (3), the maximum temperature of the furnace in which the drying and pyrolysis steps take place is set at 150° C. in order to protect the surfactant and the corrosion inhibitor.

The particles are recovered directly in step (5) on the filter and optionally dried in air.

### Example 2: Synthesis of Micronic Mesostructured Particles Loaded with 8-Hydroxyquinoline (8-HQ)-Hydrochloric Acid (HCl) Sol-Gel Catalyst

The following compounds are added, in order and under magnetic stirring: 27.50 g of a 0.1M aqueous solution of AcOH and 5.30 g of TEOS (i.e. 1.5 g of silica). The solution is then kept stirring at 25° C. for 24 hours in order to enable the hydrolysis-condensation of the TEOS. After aging, 0.50 g of Brij®C10 (i.e. 0.03 mol/mol Si) and 0.61 g of 8-HQ powder are dissolved in 5.82 g of ethanol. Heating at 37° C. for 5 minutes may be used in order to favor the dissolving of the Brij®C10 and the 8-HQ, then this solution is added to the silica precursor/Brij®C10 solution.

The silica precursor/Brij/8HQ solution is nebulized by the spray pyrolysis process according to the invention in step (1).

In steps (2) and (3), the maximum temperature of the furnace in which the drying and pyrolysis steps take place is set at 150° C. in order to protect the surfactant and the corrosion inhibitor.

The particles are recovered directly in step (5) on the filter and optionally dried in air.

Characterizations of the mesostructured particles obtained in examples 1 and 2: The characterization of the particles is carried out both on the powder dried in the oven at 60° C. (scanning electron microscopy—SEM/x-ray diffraction—SAXS and also after a step of calcination in air at 550° C. for 8 hours (scanning electron microscopy—SEM/transmission electron microscopy—TEM/nitrogen volumetric analysis/GISAXS).

These particles are spherical and have a mesostructure referred to as vermiform (TEM), a small-angle correlation peak (GISAXS) between 5 and 7 nm, a mean diameter centered between 700 and 900 nm (TEM), a specific surface area after calcination of from 100 to 500 m²/g (nitrogen volumetric analysis) and a pore diameter of from 2 to 6 nm.

### Example 3: Preparation of Micronic Particles Loaded with Benzotriazole (BTA)

Preparation of the solution: the following compounds are added, in order and under magnetic stirring, to a polypropylene flask: 30.0 g of a commercially aqueous solution containing 40% by weight of silica nanoparticles having a diameter of 10-30 nm (preferably 20 nm) then a mixture containing 4.00 g of BTA powder and 25.0 g of ethanol.

The silica precursor/BTA solution is nebulized by the spray pyrolysis process according to the invention in step (1).

In steps (2) and (3), the maximum temperature of the furnace in which the drying and pyrolysis steps take place is set at 150° C. in order to protect the corrosion inhibitor.

The particles are recovered directly in step (5) on the filter and optionally dried in air.

1. A set of micrometric spherical inorganic or hybrid particles, wherein the particles are mesostructured and individualized, and in that they contain corrosion inhibitors, said particles being prepared and loaded with corrosion inhibitors concomitantly.

2. The set of particles as claimed in claim 1,
wherein each particle is not formed by the clustering of several particles of small size.

3. The set of particles as claimed in claim 1, wherein the particles have a sphericity coefficient of greater than or equal to 0.75.

4. The set of particles as claimed in claim 1, wherein the particles have a diameter of between 0.1 and 600 micrometers.

5. The set of particles as claimed in claim 1, wherein the particles have a three-dimensional network formed at least partly by an inorganic component selected from alumina, boehmite, silica, zinc oxide, copper oxide, titanium dioxide, mixed titanium silicon oxide, montmorillonite, hydrotalcite, magnesium dihydroxide, magnesium oxide, yttrium oxide, cerium dioxide, calcium copper titanate, barium titanate, iron oxide, magnesium sulfate.

6. The set of particles as claimed in claim 1, wherein the particles comprise one or more organic and/or inorganic corrosion inhibitors.

7. The set of particles as claimed in claim 1, wherein the particles comprise one or more inorganic corrosion inhibitors which are selected from the group consisting of corrosion inhibitors comprising rare-earth elements, preferably salts of cerium, neodymium (III) and praseodymium (III), and/or molybdates, vanadates, tungstates, phosphates, or salts of cobalt Co(III), and of manganese Mn(VII), and a mixture thereof.

8. The set of particles as claimed in claim 1, wherein the particles comprise one or more organic corrosion inhibitors which are selected from the group consisting of inhibitors of azole, amine, mercaptan, carboxylate or phosphonate types and a mixture thereof.

9. A method for preparing a set of particles as claimed in claim 1, comprising the following non-dissociable and continuous steps in one and the same reactor:
(1) nebulization, in a reactor, of a liquid solution containing one or more precursors of the three-dimensional network of the particles at a given molar concentration in a solvent, so as to obtain a mist of droplets of solution, the liquid solution additionally comprises at least one corrosion inhibitor and optionally at least one surfactant,
(2) heating of the mist at a so-called drying temperature capable of ensuring the evaporation of the solvent and the formation of particles,
(3) heating of these particles at a so-called pyrolysis temperature capable of ensuring the transformation of the precursor(s) in order to form the inorganic portion of said network,
(4) optionally, densification of the particles, and
(5) recovery of the particles thus formed,
the steps (2), (3), and optionally (4), are carried out in one and the same reactor.

10. The method as claimed in claim 9, wherein:
the nebulization step (1) is carried out at a temperature of from 10° C. to 40° C., and/or preferably over a duration of less than or equal to 10 seconds, in particular less than or equal to 5 seconds, and/or
the heating step (2) is carried out at a temperature of from 40° C. to 120° C., and/or preferably over a duration of less than or equal to 10 seconds, in particular between 1 and 10 seconds, and/or
the so-called pyrolysis step (3) is carried out at a temperature of from 120° C. to 400° C., and/or preferably over a duration of less than or equal to 30 seconds, in particular between 10 and 30 seconds, and/or
the optional densification step (4) is carried out at a temperature of between 200° C. and 1000° C.

11. The method as claimed in claim 9, wherein a precursor is a metallic molecular precursor comprising one or more hydrolyzable groups which is selected in the group consisting of a metal alkoxide or halide, preferably a metal alkoxide, or a metal alkynyl, of formula (1), (2), (3) or (4) below:
MZₙ (1),
L^{m}ₓMZₙ₋ₘₓ (2),
R′_{x′}SiZ_{4-x′} (3), or
Z₃Si—R″—SiZ₃ (4)
in which formulae (1), (2), (3) and (4):
M represents Al(III), Ce(III), Ce(IV), Si(IV), Zr(IV), the number between parentheses being the valence of the atom M;
n represents the valence of the atom M;
x is an integer ranging from 1 to n−1;
x′ is an integer ranging from 1 to 3;
each Z, independently of one another, is selected from a halogen atom and an —OR group, and preferably Z is an —OR group;
R represents an alkyl group preferably comprising 1 to 4 carbon atoms, such as a methyl, ethyl, n-propyl, i-propyl, n-butyl, s-butyl or t-butyl group, preferably a methyl, ethyl or i-propyl group, better still an ethyl group;
each R′ represents, independently of one another, a non-hydrolyzable group selected from alkyl groups, in particular C₁₋₄ alkyl groups, for example methyl, ethyl, propyl or butyl groups; alkenyl groups, in particular C₂₋₄ alkenyl groups, such as vinyl, 1-propenyl, 2-propenyl and butenyl groups; alkynyl groups, in particular C₂₋₄ alkynyl groups, such as acetylenyl and propargyl groups; aryl groups, in particular C₆₋₁₀ aryl groups, such as phenyl and naphthyl groups; methacryl or methacryloxy(C₁₋₁₀ alkyl) groups such as a methacryloxypropyl group; epoxyalkyl or epoxyalkoxyalkyl groups in which the alkyl group is a linear, branched or cyclic C₁₋₁₀ alkyl group and the alkoxy group comprises from 1 to 10 carbon atoms, such as glycidyl and glycidyloxy(C₁₋₁₀alkyl) groups; C₂₋₁₀ haloalkyl groups such as a 3-chloropropyl group; C₂₋₁₀ perhaloalkyl groups such as a perfluoropropyl group; C₂₋₁₀ mercaptoalkyl groups such as a mercaptopropyl group; C₂₋₁₀ aminoalkyl groups such as a 3-aminopropyl group; (amino(C₂₋₁₀ alkyl))amino(C₂₋₁₀ alkyl) groups such as a 3-[(2-aminoethyl)amino]propyl group; di(C₂₋₁₀ alkylene)triamino(C₂₋₁₀ alkyl) groups such as a 3-[diethylenetriamino]propyl group and the imidazolyl (C₂₋₁₀ alkyl) groups;
L represents a monodentate or polydentate, preferably polydentate, complexing ligand, for example a carboxylic acid, preferably a C₁₋₁₈ carboxylic acid, such as acetic acid, a β-diketone, preferably a C₅₋₂ β-diketone such as acetylacetone, a β-ketoester, preferably a C₅₋₂₀ β-ketoester, such as methyl acetoacetate, a β-ketoamide, preferably a C₅₋₂₀ β-ketoamide such as an N-methylacetoacetamide, an α- or β-hydroxyacid, preferably a C₃₋₂₀ α- or β-hydroxyacid such as lactic acid or salicylic acid, an amino acid such as alanine, a polyamine such as diethylenetriamine (or DETA), or a phosphoric acid or a phosphonate;
m represents the degree of hydroxylation of the ligand L; and
R″ represents a non-hydrolyzable function selected from alkylene groups, preferably C₁₋₁₂ alkylene groups, for example methylene, ethylene, propylene, butylene, hexylene, octylene, decylene and dodecylene groups; alkynylene groups, preferably C₂₋₁₂ alkynylene groups, for example acetylenylene (—C≡C—), —C≡C—C≡C—, and —C≡C—C₆H₄—C≡C— groups; N,N-di(C₂₋₁₀ alkylene)amino groups such as an N,N-diethyleneamino group; bis[N,N-di(C₂₋₁₀alkylene)amino] groups such as a bis[N-(3-propylene)-N-methyleneamino] group; C₂₋₁₀ mercaptoalkylene groups such as a mercaptopropylene group; (C₂₋₁₀ alkylene)polysulfide groups such as a propylene-disulfide or propylene-tetrasulfide group; alkenylene groups, in particular C₂₋₄ alkenylene groups, such as a vinylene group; arylene groups, in particular C₆₋₁₀ arylene groups, such as a phenylene group; di(C₂₋₁₀ alkylene)(C₆₋₁₀ arylene) groups such as a di(ethylene)phenylene group; N,N′-di(C₂₋₁₀ alkylene)ureido groups such as an N,N′-dipropyleneureido group; and the following groups:
of thiophene type such as 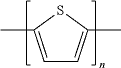
with n=1-4,
of C₂₋₅₀ aliphatic and aryl(poly)ether or (poly)thioether type, such as —(CH₂)ₚ—X—(CH₂)—, (CH₂)ₚ—C₆H₄—X—C₆H₄—(CH₂)—, —C₆H₄—X—C₆H₄—, and —[(CH₂)ₚ—X]_{q}(CH₂)ₚ—, with X representing O or S, p=1-4 and q=2-10,
of crown ether type such as 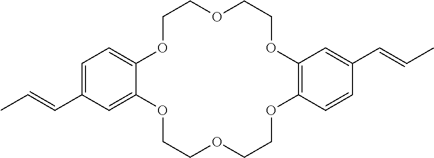 [SMILES: C/C=C/c1ccc2c(c1)OCCOCCOc1ccc(/C=C/C)cc1OCCOCCO2]
of organosilane type such as:
—CH₂CH₂—SiMe₂-C₆H₄—SiMe₂-CH₂CH₂—,
—CH₂CH₂—SiMe₂-C₆H₄—O—C₆H₄—SiMe₂-CH₂CH₂— and
—CH₂CH₂—SiMe₂-C₂H₄—SiMe₂-CH₂CH₂—,
of C₁₋₁₈ fluoroalkylene type such as —(CF₂)ᵣ— with r=1-10, —CH₂CH₂—(CF₂)₆—CH₂CH₂— and —(CH₂)₄—(CF₂)₁₀—(CH₂)₄—,
of Viologen type 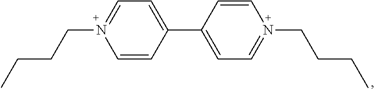
or else
of trans-1,2-bis(4-pyridylpropyl) ethene type

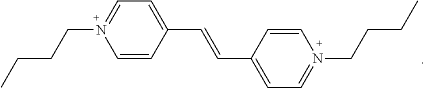

12. The method as claimed in claim 9, wherein the surfactant is an amphiphilic surfactant that is ionic, such as anionic or cationic, amphoteric or zwitterionic, or nonionic, and may additionally be photopolymerizable or thermopolymerizable.

13. The set of particles as claimed in claim 2, wherein the particles have a sphericity coefficient of greater than or equal to 0.75.

14. The set of particles as claimed in claim 2, wherein the particles have a diameter of between 0.1 and 600 micrometers.

15. The set of particles as claimed in claim 3, wherein the particles have a diameter of between 0.1 and 600 micrometers.

16. The set of particles as claimed in claim 2, wherein the particles have a three-dimensional network formed at least partly by an inorganic component selected from alumina, boehmite, silica, zinc oxide, copper oxide, titanium dioxide, mixed titanium silicon oxide, montmorillonite, hydrotalcite, magnesium dihydroxide, magnesium oxide, yttrium oxide, cerium dioxide, calcium copper titanate, barium titanate, iron oxide, magnesium sulfate.

17. The set of particles as claimed in claim 3, wherein the particles have a three-dimensional network formed at least partly by an inorganic component selected from alumina, boehmite, silica, zinc oxide, copper oxide, titanium dioxide, mixed titanium silicon oxide, montmorillonite, hydrotalcite, magnesium dihydroxide, magnesium oxide, yttrium oxide, cerium dioxide, calcium copper titanate, barium titanate, iron oxide, magnesium sulfate.

18. The set of particles as claimed in claim 4, wherein the particles have a three-dimensional network formed at least partly by an inorganic component selected from alumina, boehmite, silica, zinc oxide, copper oxide, titanium dioxide, mixed titanium silicon oxide, montmorillonite, hydrotalcite, magnesium dihydroxide, magnesium oxide, yttrium oxide, cerium dioxide, calcium copper titanate, barium titanate, iron oxide, magnesium sulfate.

19. The set of particles as claimed in claim 2, wherein the particles comprise one or more organic and/or inorganic corrosion inhibitors.

20. The set of particles as claimed in claim 3, wherein the particles comprise one or more organic and/or inorganic corrosion inhibitors.
